(19) United States
(12) Patent Application Publication
(10) Pub. No.: US 2006/0200256 A1
(43) Pub. Date: Sep. 7, 2006

(54) Programming of industrial automation equipment using RFID technology

(76) Inventors: Robert C. Mason, Wake Forest, NC (US); Ronald H. Naismith, North Andover, MA (US)

Correspondence Address: SQUARE D COMPANY;LEGAL DEPARTMENT - I.P. GROUP, 1415 SOUTH ROSELLE ROAD, PALATINE, IL, 60067, US

(21) Appl. No.: 11/072,816

(22) Filed: Mar. 4, 2005

(51) Int. Cl. G05B 11/01; G05B 19/18; G05B 19/42

(52) U.S. Cl. 700/65; 700/66; 700/86; 700/18

(57) ABSTRACT

A system, device, and method are disclosed for wirelessly coupling a controlling device to a programmable industrial control equipment such as a programmable logic controller (PLC). The controlling device may, for example, be a personal computer used for programming the PLC. The system includes a radio frequency identification (RFID) unit located at one end of this wireless connection, and also includes at least one antenna at the other end, for communicating with the RFID unit. The RFID unit acts as an intermediary for communication between the programmable industrial control equipment and the controlling device. In case a product in a production line, or a newly added input/output module, provides information that controls a PLC, this control is enhanced by the RFID connection.

### TECHNICAL FIELD

The present invention relates to Radio Frequency Identification (RFID) technology, and more particularly to RFID technology used for programming, configuring, or otherwise controlling devices such as programmable logic controllers.

### BACKGROUND OF THE INVENTION

A programmable logic controller, also called a programmable controller, is a computer-type device used to control equipment in an industrial facility. The kinds of equipment that PLCs can control are as varied as industrial facilities themselves. Conveyor systems, food processing machinery, auto assembly lines are just some examples of instances where there is probably a PLC in control. In a traditional industrial control system, all control devices were wired directly to the controlled device. In a PLC system, however, the PLC replaces the wiring between the devices. Thus, instead of being wired directly to each other, all field devices are wired to the PLC. Then, the control program inside the PLC provides the connection between the devices, and this control program is the computer program stored in the PLC's memory. The use of a PLC to provide wiring connections between system devices is called softwiring. For example, suppose a push button controls the operation of a motor; in a traditional control system, the push button would be wired directly to the motor. In a PLC system, however, both the push button and the motor would be wired to the PLC instead. Then, the PLC's control program would complete the electrical circuit between the two, allowing the button to control the motor. The softwiring advantage provided by programmable controllers is one of the most important features of PLCs. Softwiring makes changes in the control system easy and inexpensive. If one desires that a device in a PLC system behave differently or control a different process element, it is merely necessary to change the control program. In a traditional system, making this type of change would involve physically changing the wiring between the devices, which is typically a costly and time-consuming endeavor.

A PLC typically includes two basic elements: a central processing unit (CPU), and an input/output system. The CPU is the part of a programmable controller that retrieves, decodes, stores, and processes information. It also executes the control program stored in the PLC's memory. It functions much the same way the CPU of a regular computer does, except that it uses special instructions and coding to perform its functions. The CPU typically includes three basic parts: the processor, the memory system, and the power supply. The processor is the section of the CPU that codes, decodes, and computes data. The memory system is the section of the CPU that stores both the control program and data from the equipment connected to the PLC. The power supply is the section that provides the PLC with the voltage and current it needs to operate. The input/output (I/O) system of a PLC is where various controlled field devices are connected. The I/O system is what actually physically carries out the control commands from the program stored in the PLC's memory.

The CPU of a PLC has to be reprogrammed as better software becomes available, as new field devices are connected to the I/O system, and as the existing field devices are used in new and different ways. To accomplish this reprogramming, a programming device such as a personal computer can be used, and this device may be permanently connected to the PLC, or it can merely be connected when a need for reprogramming arises. Either way, the connection between programming device and PLC is typically via a wireline or other physical connection, according to the prior art.

As industrial control equipment becomes more technologically sophisticated, more and more of the equipment's functions become programmable. That means that the equipment must be configured or programmed at some point in its build and install cycle. In addition, as the installation goes through its service life, its configuration is often changed, necessitating additional programming. There are also times when it is desired to load data from equipment for use in diagnostics, to copy an existing configuration, to perform maintenance functions, and the like.

The traditional method for performing this upload and/or download is to plug into a communication port on the programmable equipment. Doing this with the equipment powered up requires that special care be taken to protect against static discharge, power surges, and incorrect polarity of signals. In addition, there is sometimes a concern with galvanic isolation to protect against hazardous voltages which may be present on either of the pieces of equipment involved. Similar concerns are found when a memory connection or memory card is used.

RFID technology has become well-known over the past few decades, and its wireless potentialities continue to be expanded and exploited, although to date no way has been proposed for using RFID technology to address the problems encountered when programming control equipment.

Implementing an RFID device has certain basic features. The simplest RFID device is the TAG. The tag is typically a completely passive device in that it contains no internal power source; it derives its operating power from the RF field used to interrogate the tag. A passive RFID Tag 100 is shown as a block diagram in FIG. 1.

The tag's only link to the outside world is normally the antenna 110, shown in FIG. 1 with connections LA and LB. When the antenna picks up an RF field of the proper amplitude and frequency, an operating voltage is generated that can power 120 the tag. The demodulator 130 extracts commands and data from the RF field and passes them along. The digital control block 140 interprets the received commands and data and formats responses. Tag responses are encoded and transmitted by the modulator 150. The memory block 160 stores received data and supplies data for responses. Since the operating voltage comes from the RF field, the contents of a volatile memory are lost when the field is not present. Non-volatile memory contents are maintained even in the absence of an RF field.

This tag architecture is described herein as a passive RFID device, wherein the entire data module is completely passive. As mentioned, the tag's only link to the outside world is normally the antenna, which is true for commercially available tags.

An active device is used in order to read from or write to a passive tag. This active device is commonly known as a reader/writer. The reader/writer generates the RF field that powers the tag. The reader/writer formats and transmits commands to the tag and receives responses back from the tag. FIG. 2 shows the block diagram of a reader/writer 200.

A higher-level device such as a computer or embedded micro-controller (the host system 210) controls operation of the reader/writer, which utilizes an RF board. In effect, the reader/writer is a kind of modem or transceiver that interfaces between the host system 210 and the RFID tag. Typically the reader/writer does no processing of the data passing between the RFID tag and the host system; it merely passes data between the two. With these two devices (i.e. the tag and reader/writer), systems can be built. The simplest system 300 consists of a host system 210, a reader/writer 200, and a tag 100, as shown in FIG. 3. To date, the potentialities of an RFID system 300 have not been harnessed and modified so as to facilitate the programming of a PLC or any similar control equipment.

Suppose a line of products flows through an assembly line, and some of those products are different from others, thus requiring different assembly techniques, or suppose that identification data for each product must be carefully recorded (e.g. for pharmaceuticals). Existing barcode scanning is prone to error and requires a very precise relative orientation between the product and a barcode reader. Likewise, identifying products by human observation, accompanied by a human/machine interface (HMI), is also subject to error, as well as high labor costs. Thus, a more efficient way to identify products is needed, especially so that a PLC can properly control the continued assembly of a product. Similarly, a user who attaches a new input/output module to a PLC may need to find out if there will be a configuration problem, before going to the trouble of establishing a physical electrical connection between the I/O module and the PLC, and thus a better way to identify I/O modules is needed.

Furthermore, many industrial control installations must face the problem of isolating one circuit or equipment from another, while still allowing communication between them. This is usually accomplished by means of a transformer or an optical coupler. In either case, contact points must be brought out, and wires routed between the two devices. Often, special constraints apply to those wires, in order to maintain the necessary separation. It would be useful to streamline these cumbersome procedures and systems for galvanic isolation of industrial control equipment.

### SUMMARY OF THE INVENTION

According to the present invention, a system, device, and method enable a programming device to be wirelessly coupled to programmable industrial control equipment. The system includes a radio frequency identification (RFID) unit that acts as an intermediary for communication between the control equipment and the programming device. An RFID link is used to replace hard connectors when connecting between a device and a piece of industrial control equipment that is controlled by the device. This connection is usually a temporary one, made for the purpose of programming, configuring or transferring data.

While RFID systems can be set up to operate at many different frequencies and at varying distances from the antenna, the present invention concentrates on systems that operate on the principle of proximity coupling. If the RF operating frequency of a proximity coupling system is chosen well, all components of the system, including the antenna, can be integrated into a simple printed wiring board. The antenna itself can be implemented as traces on the printed wiring board; i.e. the antenna need not be a separate component.

An appropriate RF connection eliminates the problems of the prior art. An antenna, packaged in a plastic housing for example, can be inserted into a slot or placed on the surface of the equipment to which (or from which) information will be loaded. Thus, there is no direct physical connection, so there is no longer a problem with static electricity, power surges, polarity, or isolation. Data rates for this application can exceed 200 kilobits per second (kbps), so lengthy data transfer times can be avoided. If the power consumption of the RF pod is kept low (at about 25 to 50 milliwatts), then the RF pod can be powered by an RF field from the field device (e.g. the PLC), or by communication port power from the personal computer (PC) that is being used to program the programmable control equipment. The RF Pod can be as simple as an antenna, or as complex as a complete RFID reader/writer including an antenna.

A special case for uploading or downloading data is one where the entire data module is completely passive. The data module can extract all of its operating power from the RF field. An operator can place one of these passive device modules in a defined location, and he can then read data from, or write data to, the module. If the module has non-volatile memory, such as EEPROM or FERAM, then the module will retain the data without the presence of an RF field, battery, or any other power source. Thus, an operator can copy a configuration from one piece of equipment, pick up the module, place it into his pocket (without any concerns about static electricity), and walk over to another piece of equipment to upload the same configuration to it.

In conjunction with this scenario, an RFID device can also be used as a security key. A given piece of industrial control equipment can be programmed to operate only if a module containing specific permission codes is in close proximity to its antenna area. Quite lengthy permission codes can be programmed into a piece of industrial control equipment, in excess of a thousand bytes, which makes it effectively impossible to break the security code.

With or without the security key feature, the present system is for wirelessly coupling a controlling device to a piece of programmable industrial control equipment. The equipment can then be at least partly controlled by the controlling device. The controlling device may program the equipment, configure the equipment, supply data to the equipment, remove data from the equipment, or coordinate security codes with the equipment so that the equipment will only function provided that the controlling device is nearby. The system includes a first radio frequency identification (RFID) unit located at the equipment for communication therewith, and this may be an RFID tag, or an RFID reader/writer. The system also includes at least one antenna at the controlling device, for communicating with the RFID unit. This RFID unit acts as an intermediary for communication between the controlling device and the equipment.

According to one embodiment, this invention is useable with the industrial control equipment in the production of a plurality of products. For example, a line of products may flow through an assembly line, and some of those products may be different from others, thus requiring different assembly techniques. By equipping at least some of the products with RFID tags, these products can be more easily recognized by a programmable logic controller so that, by identifying itself, the product controls how it will be assembled, tested, or processed. In this scenario, there can be one RFID connection, or more than one RFID connection (e.g. an RFID connection from the product to an I/O module and then an RFID connection from the I/O module to a CPU of the PLC). Likewise, such an RFID connection can be used to more easily record data about the product (e.g. serial numbers), which is important for pharmaceutical and other products. This RFID connection improves upon existing barcode scanning, which is prone to error, which requires a very precise relative orientation between a product and a barcode reader, and which severely limits the amount of data that can be communicated. Identifying products by human observation, accompanied by a human/machine interface HMI, is also subject to error, as well as high labor costs. Adapting RFID technology to this problem allows automated alteration of process parameters and/or recipes, based upon the current product flowing through the line. It eliminates operator intervention and possible error in inputting the type of product currently flowing through a line.

In another embodiment of the invention, a newly added input or output module at least partly controls a PLC, by identifying itself via RFID, and thus the I/O module lets the PLC know how to configure or control the new module. The subsequent interaction between PLC and I/O module can be either by traditional wired connection, or by wireless connection. Using this RFID technique for identification purposes also allows a user to more easily maintain or upgrade a system by allowing automatic or semi-automatic configuration (or attempted configuration) of new modules added to the system.

Since RFID relies on contactless electromagnetic coupling, no direct connections are needed to connect two pieces of equipment. Insulating barriers, so long as they are non-metallic, are no impediment to the electromagnetic signals. Thus, two independent circuits may communicate by means of antenna-to-antenna coupling through an insulating barrier. The presence of an insulating barrier eliminates concerns about routing and separation. A secondary benefit of RF coupling is that the data exchange connection has no sensitivity to the polarity of the signals. The signals cannot be connected incorrectly by an installer or user; the antennas either couple or they do not. Thus, it is not only possible, but also highly advantageous, to achieve galvanic isolation of industrial control equipment using RF proximity coupling.

### BRIEF DESCRIPTION OF THE DRAWINGS

FIG. 1 shows a prior art RFID tag.

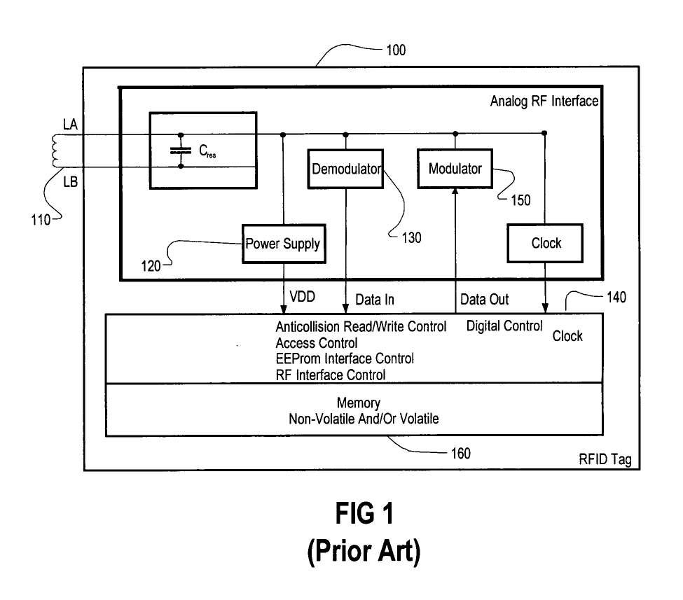

FIG. 2 shows a prior art reader/writer.

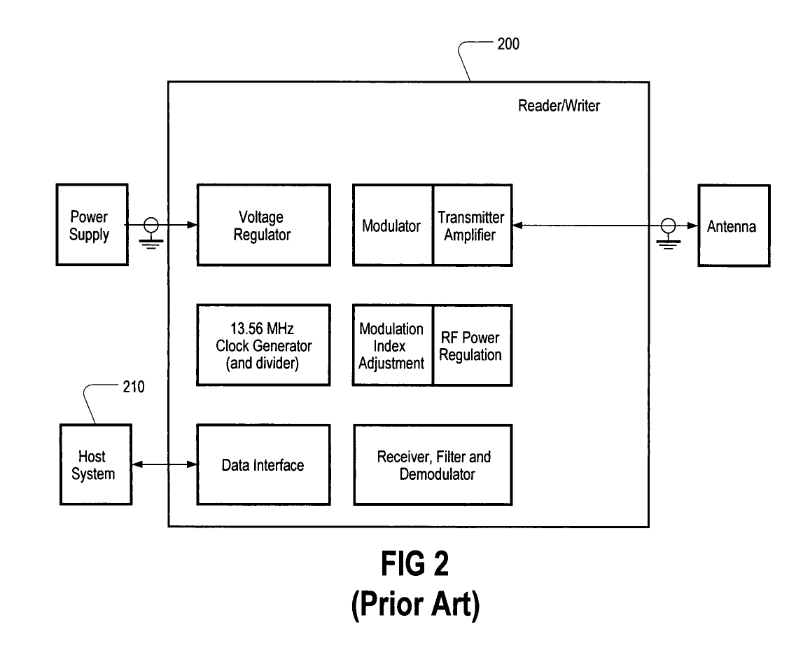

FIG. 3 shows a prior art system utilizing an RFID tag and reader/writer.

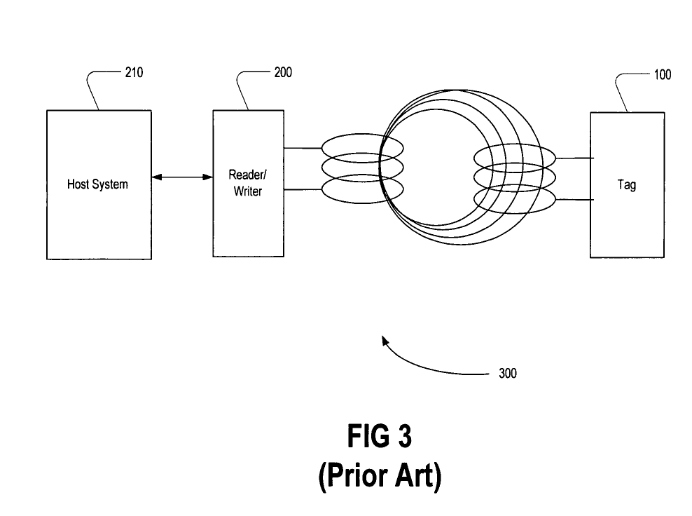

FIG. 4 shows an RF field being used for programming purposes.

FIG. 5 shows industrial control equipment that is using separate wireless connections for connecting an input/output module and also for programming.

FIG. 6 shows how a single user interface and RF field can be used for multiple purposes including programming.

FIG. 7 illustrates a method according to an embodiment of the present invention.

### BEST MODE FOR CARRYING OUT THE INVENTION

Unlike traditional radio methods, infrared methods would not be at all comparable to the technique of the present invention because infrared is limited by line-of-sight issues as well as performance problems caused by the often-dirty industrial environment. At the top level, traditional radio methods significantly differ from the present invention by the frequency of the signals. The lower frequencies of traditional radio require large antennas that are difficult to fit into electronic packaging. RFID antennas, by comparison, take up about 1 square inch of printed wiring board (PWB) area. The nature of the RF field makes it very selective as to what devices will be affected by it. Unless an antenna is placed in close proximity to the transmitter (e.g. only a fraction of a centimeter away) it will not detect or respond to the signal. This makes RFID much more selective than traditional radio transmission.

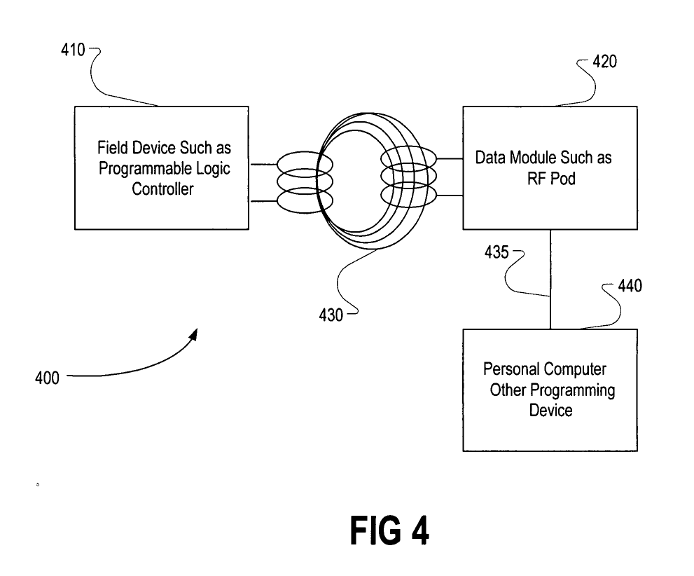

As seen in FIG. 4, a system 400 includes the field device which may be a piece of industrial control equipment 410, such as a programmable logic controller (PLC) or part thereof. The PLC can tap into an RF field 430 in order to communicate with a data module 420. The short range of these RF fields allows the data module to interact with a distinct field, and thus there is no need to distinguish from other RF fields, such as an RF field connecting the PLC to input/output modules that are controlled by the PLC.

The term “Data Module” is a general term for a component used to hold and/or transport data. An RF Pod can be a specific kind of data module that uses RFID technology to transfer data into and out of it. An RFID Tag is an industry-standard term for a simple device, often a single integrated circuit, that can operate according to the RFID standards and provide data to an RFID Reader/Writer; an RFID Tag is a specific kind of RF Pod 420. According to this hierarchy, the most general term is a data module, an RF Pod is a more specific term, and the most specific term is an RFID Tag.

The field device 410 represents any piece of programmable industrial control equipment (such as a PLC, a meter, or a data logger) that is used in a factory or other installation. The use of the word “field” in “field device” refers to the fact that the device 410 is being used in a working installation (the “field”) as opposed to being in some controlled environment such as a laboratory. The field device needs to be configured and/or read from time to time. In this context, the particular field device 410 is distinct from other devices controlled by the field device. The RF Field 430 is the radio frequency electromagnetic field created, for example, by the transmitting antenna in the RF Pod 420. The use of the word “field” in “RF field” refers to an electromagnetic field as defined in physics textbooks, in contrast to use of the word “field” in the term “field device.”

Both the RF Pod 420 and the Field Device 410 have antennas that are sensitive to the RF field 430. The RF Pod is a device that, in some scenarios, generates the RF Field. However, in other embodiments of the present invention, the Field Device instead of the RF pod generates the RF Field. In any event, the RF Pod modulates the RF Field in order to send signals to the Field Device. The RF Pod also detects communications from the Field Device through the same RF Field. In the scenario that has the RF Pod generating the RF Field, the commands and data that the RF Pod sends to the Field Device come from the PC via a wired or wireless connection 435. The responses from the field device are then relayed on to the PC. The acronym PC refers to a Personal Computer 440 or any other such device that can control the process of programming the field device. The PC is capable of serving as the master controller of this programming process. However, if the Field Device 410 generates the RF Field, then the Field Device also controls the communications process with the RF Pod, in which case there may not be any need for a PC or similar unit to be present. These two scenarios (creating the field by the field device or instead creating the field by the RF Pod) are equally feasible; they represent different systems that can be set up using the RFID technology.

The RF Pod 420 does not always have to be connected by wire to a PC 440, and in some situations there will be no PC at all. Those are the times when it would be advantageous to have the RF Pod powered by the RF Field. This concept may be likened to a USB flash drive that can be plugged into a USB port on a computer. One can plug the flash drive into a USB port, copy files to the flash drive, unplug the flash drive from the computer, and carry the flash drive to another computer, where the files can be copied to the second computer. The USB port provides the power to operate the flash drive. The present invention can accomplish the same thing, while doing away with the connector needed for the USB port.

In some cases, the RFID equipment of the present invention will need more power than can reasonably be extracted from the RF field. In those cases, the RFID approach is still advantageous because of economy and simplicity, in addition to advantages already mentioned. The RFID tag can be situated at the field device 410 if the field is created by the RF Pod 420, in which case the RF Pod 420 may include an RFID reader/writer; alternatively, the RFID tag will be located at the RF Pod 420 and the reader writer would be located at the field device 410.

Some of the advantages of the present inventive concept are elimination of points of potential failure (connectors are notorious for failing due to dirt, corrosion, wear, and the like), simplifying assembly (no connectors to line up and seat), eliminating the possibility of mismatched connectors or reversing polarity of signals and, of course, galvanic isolation. Isolation is a major concern in industrial controls.

An additional use of this concept would be to use the RF Pod to create a security lock and key, and this feature may be conveniently combined with the programming function. There are times when it is desired to lock the PLC against unauthorized operation or modification, and that is typically accomplished via a password or a physical keylock, but that type of password can be compromised and that type of key can be copied. An RFID tag, however, is more difficult to copy and practically impossible to be compromised. The security lock function is an additional possible use of the RFID technology, either separate from or conveniently combined with the programming function. The field device 410 would have to be programmed with the appropriate access codes used by the RF Pod 420, and in this sense the two concepts are highly interrelated.

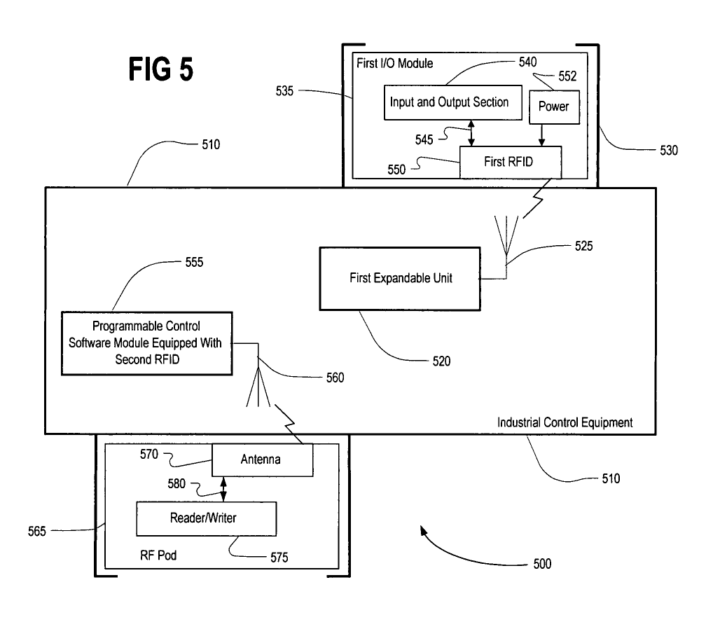

FIG. 5 shows a system 500 according to an embodiment of the present invention. Industrial control equipment 510 is expandable. In particular, the equipment 510 has a first expandable unit 520 which is equipped with an antenna 525. The industrial control equipment 510 includes attaching means 530 such as a bracket or slot for holding a first I/O module 535 which expands the first expandable unit 520. The first I/O module 535 includes an input and output section 540 that has a physical or wireless connection 545 to the first RFID 550 which is embedded in the first I/O module 535. The first I/O module 535 further includes a power supply 552 providing auxiliary power to the RFID 550 so that it can more reliably communicate with the antenna 525.

The industrial control equipment 510 also includes a programmable control software module equipped with a second RFID, and this module 555 is capable of being reprogrammed. The RF Pod 565 is able to wirelessly provide programming to the module 555, without any interference or confusion with the first expandable unit 520 and its own wireless connection to the I/O Module 535, because the two RF fields are substantially separate. An operator can place the device module 565 in a defined location. He can then read data from, or write data to, the module. Of course, the second RFID can be switched with the reader/writer 575, in which case the device module 565 would be passive.

Sometimes, the procedure to set up and configure control equipment is long and complex. There may be many parameters to enter and many decisions to be made as to how the equipment will operate. Often, only an engineer or highly-trained operator is knowledgeable enough to make those decisions; a regular operator or technician may not have the necessary background. But, once the equipment configuration is complete, it is then usually a much simpler task to copy the configuration into another piece of equipment that will use the same software setup. That copying task is well within the means of a technician or operator, who needs only to insert the module 565 shown in FIG. 5 into the designated location, and execute a relatively simple command sequence to copy the setup data to the module. At the next piece of equipment, the operator can reverse the process to copy the setup data from the module 565.

It is possible, but not always necessary, for this programming process to require some sort of permission code or authentication. That authentication could be a simple password-type keystroke sequence at the user interface, or it could be tied to the presence of a permission code contained in the module 565, thus combining the roles of security and data transfer in one device.

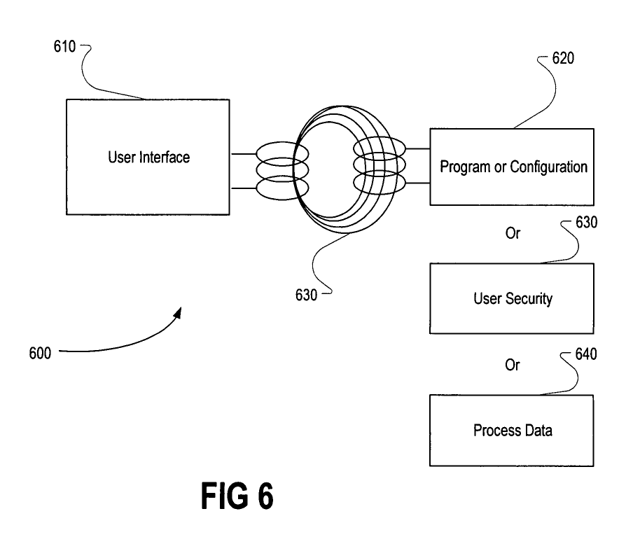

As seen in FIG. 6, the user interface 610 serves as the means by which the operator programs the control equipment. In this embodiment, the user interface is where the operator places the passive device module, and is also where the operator directs the equipment to read from or write to the module. Therefore, not only is the user interface part of the same unit that houses the passive RFID device, but also the user interface 610 contains the means to house the passive RFID device (e.g. RFID tag). Regarding the three items on the right-hand-side of FIG. 6, only one of these three items is connected to the RF field at a time. In other words, the passive RFID module can be used to transfer program or configuration data 620 as already discussed or it can act as a security key 630 as already discussed, or it can transfer process data 640 from control and/or monitoring equipment to a center data collection point.

With respect to the process data 640, suppose a piece of equipment were located in some remote location where it is impractical to have a wired connection for data gathering. One option, of course, would be to have a wireless radio link, but that may not be acceptable for any number of reasons. Therefore, an operator nowadays must go to the equipment and plug in a cable and download the stored data to his portable computer or some similar device. However, according to an embodiment of the present invention, the concept is to replace that cable and portable computer with the RFID module. The RFID module eliminates the cable and its connector, which have always been a source of reliability problems. An RFID-type connection is less susceptible to weather-related and environment-related problems than a wired connection, and there is also less equipment for the operator to carry to the site.

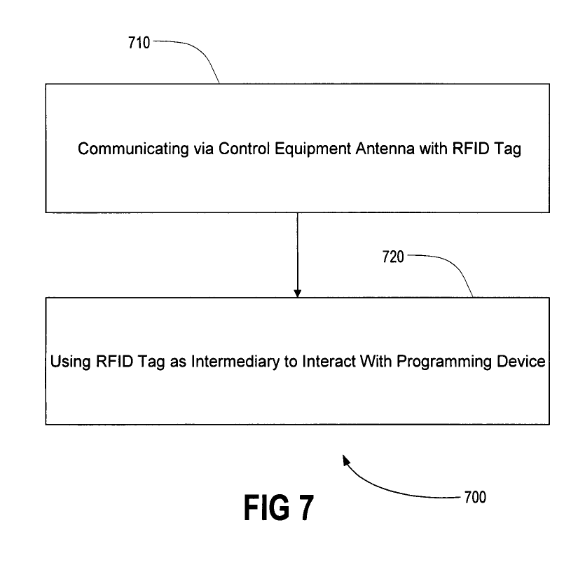

FIG. 7 simply sketches the method 710 according to an embodiment of the present invention. The first step is communicating 710 via an antenna included in the industrial control equipment, in order to reach an RFID. Then, the second step is using the RFID 720 as an intermediary to reach a programming device.

Various changes may be made in the above illustrative embodiments without departing from the scope of the invention, as will be understood by those skilled in the art. It is intended that all matter contained in the above description or shown in the accompanying drawings shall be interpreted as illustrative and not in a limiting sense. The invention disclosed herein can be implemented by a variety of combinations of hardware and software, and those skilled in the art will understand that those implementations are derivable from the invention as disclosed herein.

What is claimed is:

1. A system for wirelessly coupling a controlling device to a piece or module of programmable industrial control equipment that is at least partly controlled by the controlling device, comprising:
a first radio frequency identification (RFID) unit located at the equipment for communication therewith; and
at least one antenna at the controlling device, for communicating with the RFID unit,
wherein the RFID unit acts as an intermediary for communication between the controlling device and the equipment.

2. The system of claim 1, wherein the at least one antenna at the controlling device is part of a second RFID unit,
wherein either the first RFID unit or the second RFID unit comprises a passive RFID tag powered at least partly by an electromagnetic field external to the passive RFID tag, and
wherein the electromagnetic field is for communicating between the controlling device and the industrial control equipment via proximity coupling.

3. The system of claim 2, wherein the proximity coupling between the controlling device and the industrial control equipment is substantially separate from another proximity coupling between the industrial control equipment and at least one input/output module controlled at least partly by the industrial control equipment.

4. The system of claim 1, wherein the controlling device is for at least partly controlling the programmable industrial control equipment by programming, transferring data, or configuring.

5. The system of claim 4, further comprising a second programmable industrial equipment, wherein the controlling device is portable for movement to or from the second programmable industrial equipment, and wherein at least part of the data is transferrable between the controlling device and the second programmable industrial equipment.

6. The system of claim 1, wherein the controlling device acts as a security key in that a function of the equipment is forbidden unless the controlling device is sufficiently proximate to the equipment.

7. The system of claim 6, wherein a permission code or authentication information for activation of the security key is at least part of the communication between the controlling device and the equipment.

8. The system of claim 1, wherein the at least one antenna is implemented as a set of traces on a printed wiring board.

9. The system of claim 1, wherein the system and the industrial control equipment are useable in production of a plurality of products,
wherein, during at least part of the production, at least one of the products contains or is attached to a passive RFID tag comprising the at least one antenna, and
wherein the at least one of the products serves as the controlling device by identifying itself and therefore letting the industrial control equipment know how to continue the production of the product, or know information needed to log data pertaining to the product.

10. The system of claim 1, wherein an input or output module serves as the controlling device by identifying itself and therefore letting the industrial control equipment know how to configure or control the module.

11. The system of claim 10, wherein the industrial control equipment controls the module via a physical electrical connection.

12. The system of claim 10, wherein the industrial control equipment controls the module via a wireless connection.

13. The system of claim 1, wherein the RFID unit galvanically isolates the industrial control equipment from the controlling device.

14. The system of claim 1, further comprising a non-metallic insulating barrier for galvanically isolating the piece or module of the programmable industrial control equipment, from the controlling device or other apparatus that communicates with the piece or module.

15. Programmable industrial control equipment for wirelessly coupling to a controlling device that at least partly controls the equipment, comprising:
a first radio frequency identification (RFID) unit located at the equipment for communication therewith; and
attaching means for removably attaching the controlling device so that the controlling device is positioned for wireless communication with the programmable industrial control equipment via proximity coupling.

16. A method for wirelessly coupling at least one controlling device to a piece or module of industrial control equipment, comprising:
communicating, via an antenna at the controlling device, with a radio frequency identification (RFID) unit, and
using the RFID unit as an intermediary for communication between the industrial control equipment and the controlling device,
wherein the RFID unit is located at the equipment for communication therewith, and wherein the controlling device is for at least partly controlling the industrial control equipment.

17. The method of claim 16, wherein the communication includes programming by which the controlling device programs the industrial control equipment.

18. The method of claim 16, wherein the industrial control equipment is useable in production of a plurality of products,
wherein, during at least part of the production, at least one of the products contains or is attached to a passive RFID tag comprising the antenna, and
wherein the at least one of the products serves as the controlling device by identifying itself and therefore letting the industrial control equipment know how to continue the production of the product, or know information needed to log data pertaining to the product.

19. The method of claim 16, wherein an input or output module serves as the controlling device by identifying itself and therefore letting the industrial control equipment know how to configure or control the module.

20. The method of claim 16, wherein the RFID unit galvanically isolates the industrial control equipment from the controlling device.

21. The method of claim 16, wherein a non-metallic insulating barrier galvanically isolates the piece or module of the industrial control equipment from the controlling device or other apparatus that communicates with the piece or module.

22. A computer readable medium encoded with a software data structure sufficient for performing the method of claim 16.
